(19) United States
(12) Patent Application Publication
(10) Pub. No.: US 2025/0335935 A1
(43) Pub. Date: Oct. 30, 2025

(54) LAUNDRY APPLIANCES USAGE-BASED RELOCATION

(71) Applicant: Haier US Appliance Solutions, Inc., Wilmington, DE (US)

(72) Inventors: MyungGeon Chung, Seoul (KR); Wee Dayeon, Hwaseong (KR)

(21) Appl. No.: 18/650,673

(22) Filed: Apr. 30, 2024

(51) Int. Cl. G06Q 30/0201; D06F 31/00; D06F 34/05

(52) U.S. Cl. CPC G06Q 30/0201; D06F 31/00; D06F 34/05

(57) ABSTRACT

A method of operating a group of laundry appliances, such as in a laundromat, includes identifying first and second sets of laundry appliances from the group. The first set may be high-usage appliances and the second set may be low-usage appliances. The method may further include providing a recommendation to relocate at least one laundry appliance from the first set of laundry appliances or the second set of laundry appliances.

### FIELD OF THE INVENTION

The present subject matter relates generally to systems and methods for managing a group of laundry appliances, such as providing suggested or recommended relocation for such laundry appliances.

### BACKGROUND OF THE INVENTION

Laundry appliances generally include washing machine appliances and dryer appliances. Some laundry appliances, such as commercial laundry appliances, may be organized in groups, e.g., with multiple washing machine appliances and multiple dryer appliances in the group. For example, such larger groups may be found in a laundromat, dormitory, or apartment building, etc. In some instances, certain laundry appliances of the group may be used more frequently than other laundry appliances of the group. Users may, for instance, tend to avoid laundry appliances closer to the entrance of the facility, e.g., laundromat, or laundry appliances which are less convenient to reach. Thus, some laundry appliances, such as those in more preferred locations, may be used significantly more than others, and may consequently experience higher rates of wear and tear and may be more likely to experience downtime for maintenance or repair. Customers may be dissatisfied when laundry appliances are unavailable for use, especially when the unavailable appliances are in a preferred location or are otherwise preferred appliances.

Thus, systems and methods for relocating, e.g., rotating, multiple laundry appliances to more evenly distribute the usage load among the group of appliances would be beneficial.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of operating a group of laundry appliances is provided. The method includes performing a total number of cycles with the group of laundry appliances over a time period. Each laundry appliance of the group of laundry appliances performs a portion of the total number of cycles. The method also includes identifying a first set of laundry appliances from the group of laundry appliances based on the portion of the total number of cycles performed by each laundry appliance in the first set of laundry appliances. The first set of laundry appliances are high-use laundry appliances. The method further includes identifying a second set of laundry appliances from the group of laundry appliances based on the portion of the total number of cycles performed by each laundry appliance in the second set of laundry appliances. The second set of laundry appliances are low-use laundry appliances. The method also includes providing a recommendation to relocate at least one laundry appliance from the first set of laundry appliances or the second set of laundry appliances.

In accordance with another embodiment of the present disclosure, a method of operating a group of laundry appliances is provided. The method includes identifying, after a period of time, a first set of laundry appliances from the group of laundry appliances. The first set of laundry appliances performed a first portion of a total number of cycles performed by the group of laundry appliances during the period of time. The method also includes identifying a second set of laundry appliances from the group of laundry appliances. The second set of laundry appliances performed a second portion of the total number of cycles performed by the group of laundry appliances during the period of time. The second portion is less than the first portion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a schematic diagram of a laundry appliance in communication with a remote user interface device and a remote database according to one or more embodiments of the present disclosure.

FIG. 5 provides an exemplary floor plan according to one or more embodiments of the present disclosure.

FIG. 6 illustrates populating the floor plan with location information for a group of laundry appliances according to one or more embodiments of the present disclosure.

FIG. 7 provides a view of the floor plan of FIG. 6 with a group of laundry appliances added thereto.

FIG. 8 illustrates using the floor plan of FIG. 7 to provide recommended relocations for some laundry appliances in the group of laundry appliances.

FIG. 9 provides a flowchart illustrating an example method of operating a group of laundry appliances according to one or more embodiments of the present disclosure.

FIG. 10 provides a flowchart illustrating another example method of operating a group of laundry appliances according to one or more additional embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” “approximately,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

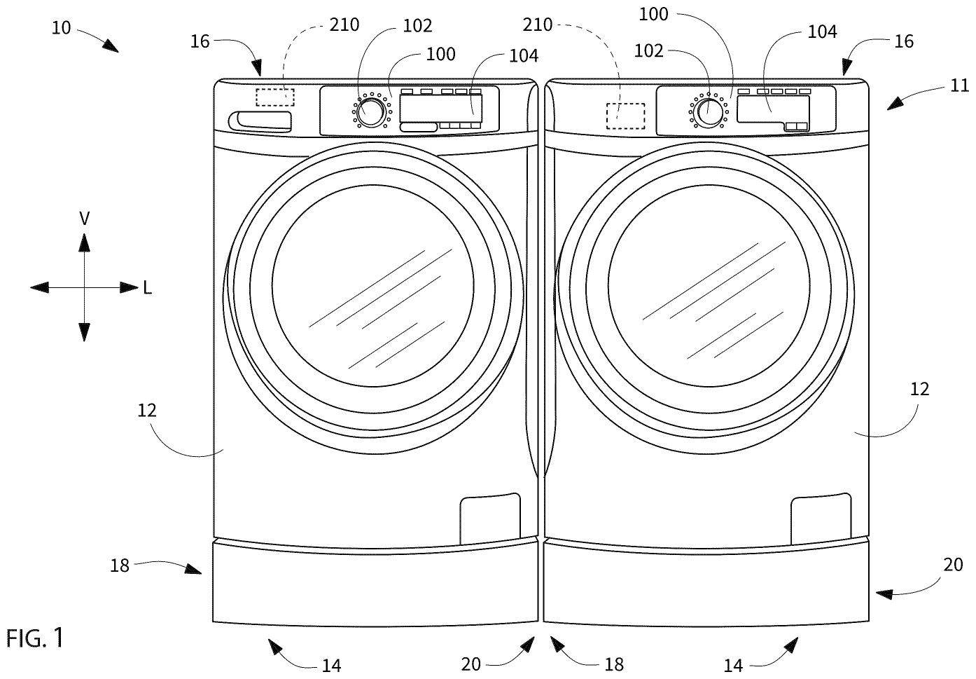

As may be seen in FIGS. 1 through 3, in accordance with one or more embodiments of the present subject matter, a group of at least two laundry appliances, e.g., a pair of laundry appliances is provided.

As may be seen generally throughout FIGS. 1 through 3, a user interface panel 100 and a user input device 102 may be positioned on an exterior of each laundry appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g., performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the group of laundry appliances may include one or more of each of a washing machine appliance 10 and a dryer appliance 11. In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each laundry appliance 10 and 11.

As generally seen throughout FIGS. 1 through 3, in at least some embodiments, each laundry appliance 10 and 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

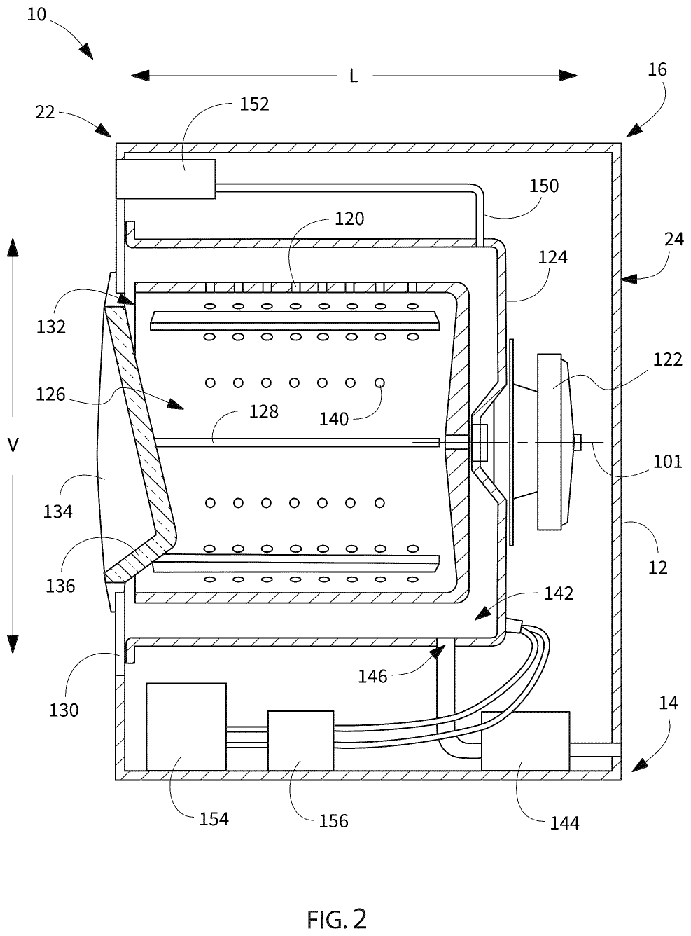

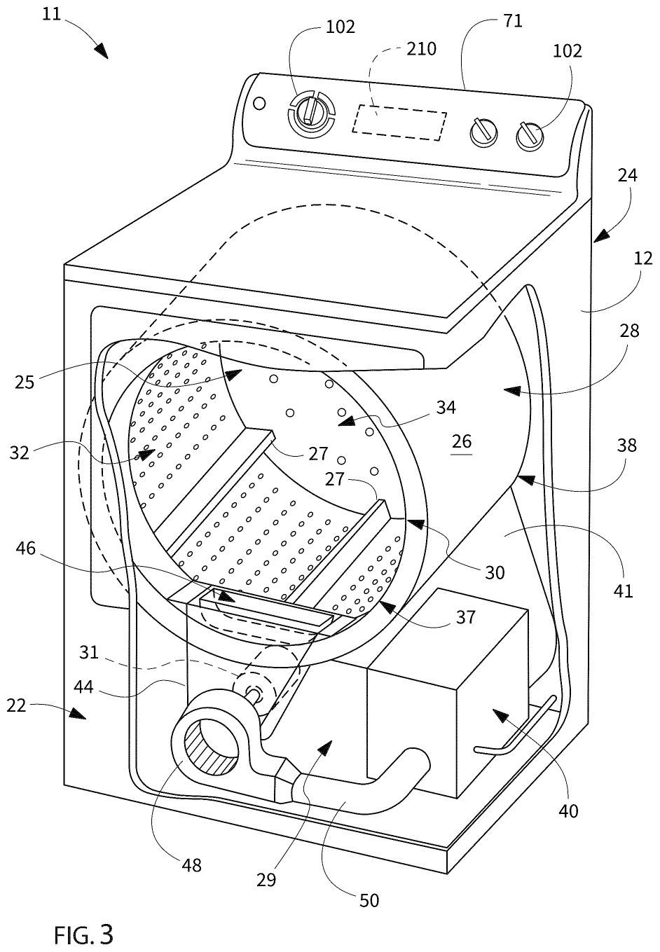

Additional exemplary details of the laundry appliances are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, e.g., during a wash cycle of the washing machine appliance 10, a laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a household appliance, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” include but need not be limited to fabrics, textiles, garments, linens, papers, or other items from which the extraction of moisture is desirable. Furthermore, the term “load” or “laundry load” refers to the combination of clothing that may be washed together in a washing machine 10 or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 11 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

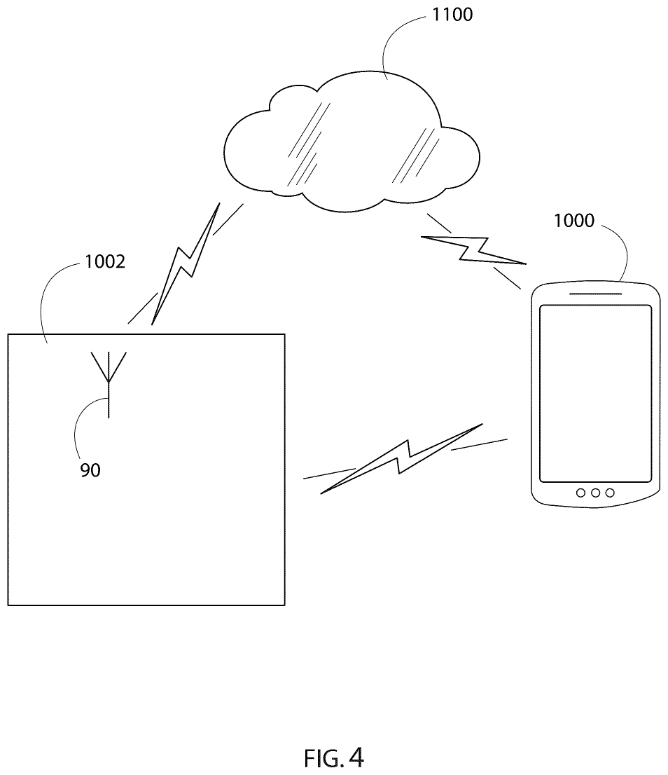

Turning now to FIG. 4, a general schematic of a laundry appliance 1002, which may be, e.g., the washing machine appliance 10 or the dryer appliance 11 described above (or both,) and communication features thereof. FIG. 4 schematically illustrates a laundry appliance 1002, which may be, for example, one of the laundry appliances 10 or 11 of FIGS. 1 through 3, among other possible example laundry appliances, which communicates wirelessly with a remote user interface device 1000. For example, as illustrated in FIG. 4, the laundry appliance 1002 may include an antenna 90 by which the laundry appliance 1002 communicates with, e.g., sends and receives signals to and from, the remote user interface device 1000. The laundry appliance 1002 may communicate with the remote user interface device 1000 over a direct wireless communication link or over an indirect wireless communication link, such as via a remote server, a network, or cloud 1100. The remote user interface device 1000 may be a laptop computer, smartphone, tablet, personal computer, wearable device, smart home system, and/or various other suitable devices.

The laundry appliance 1002 may be in communication with the remote user interface device 1000 device through various possible communication connections and interfaces. The laundry appliance 1002 and the remote user interface device 1000 may be matched in wireless communication, e.g., connected to the same wireless network. The laundry appliance 1002 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the appliance 10 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the laundry appliance 1002, e.g., the remote user interface device 1000 is a separate, stand-alone device from the laundry appliance 1002 which communicates with the laundry appliance 1002 wirelessly. Any suitable device separate from the laundry appliance 1002 that is configured to provide and/or receive communications, information, data, or commands from a user may serve as the remote user interface device 1000, such as a smartphone (e.g., as illustrated in FIG. 4), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

As mentioned above, the laundry appliance 1002 may also be configured to communicate wirelessly with a remote database 1100. The remote database 1100 may be, e.g., a cloud-based data storage system. For example, the laundry appliance 1002 may communicate with the remote database 1100 over the Internet, which the laundry appliance 1002 may access via WI-FI®, such as from a WI-FI® access point in a user's home.

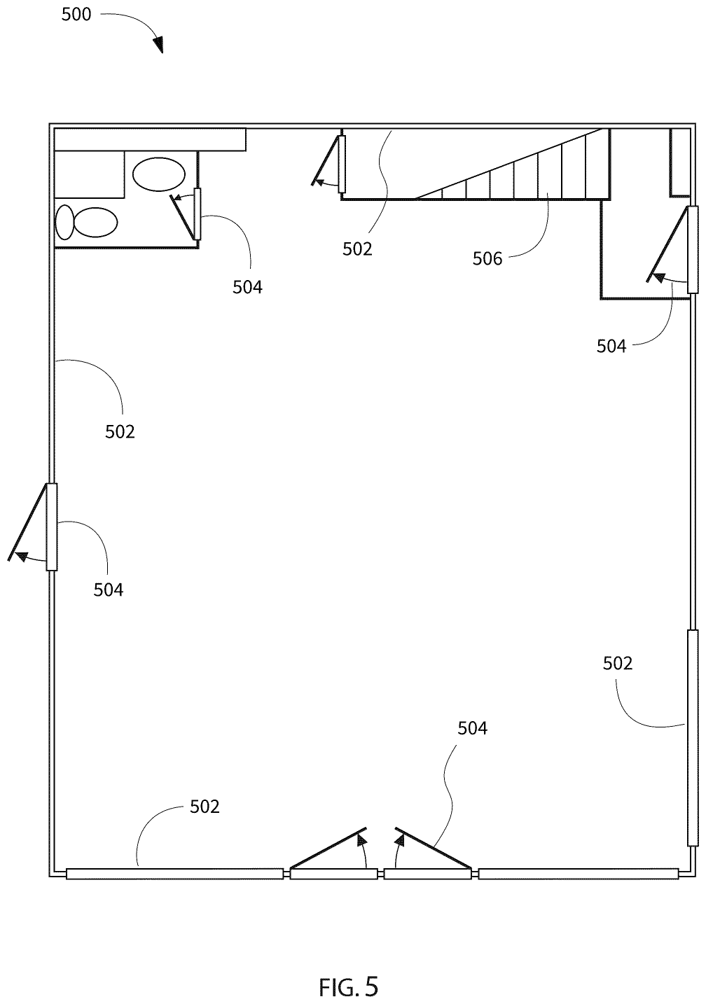

FIG. 5 illustrates an exemplary floor plan 500 of a facility, such as a laundromat, comprising one or more rooms. The floor plan 500 may be uploaded by an owner of the laundromat according to one or more embodiments of the present disclosure. The facility represented by the floor plan 500 may also be, e.g., a laundry room in a dormitory or apartment complex, or any other facility in which multiple commercial laundry appliances may be located. For example, the floor plan 500 may be uploaded to a remote computing device, such as a database or server, e.g., via the internet. In some embodiments, the remote computing device may be part of a distributed computing environment, such as the cloud, the fog, and/or the edge. The floor plan 500 may be, for example, any suitable image file format, such as but not limited to a JPEG or PDF image file that is uploaded to the remote computing device, e.g., in the cloud, from a user interface device such as a smartphone, tablet computer, laptop or desktop computer, or other similar device. For example, the floor plan 500 may be uploaded by an owner or manager of the facility, e.g., laundromat, and data (such as number and placements of laundry appliances and defined groups of laundry appliances, as described further below) may be entered or otherwise manipulated (e.g., edited, deleted) by the owner or manager using a digital representation of the floor plan 500, e.g., on a device such as a desktop computer, laptop computer, tablet computer, and other similar devices.

As illustrated for example in FIG. 5, the floor plan 500 may include a general outline of the one or more rooms of the facility, such as an indication of the location and size of walls 502 of the rooms and doors 504 therein. The floor plan 500 may also include, in some exemplary embodiments, a location of stairs 506 and other features such as plumbing fixtures, etc. Additionally, after or during the upload process for the floor plan, e.g., the upload process for the image file containing the floor plan, a prompt or input field may be provided for dimension data of the facility, e.g., laundromat, that is represented by the floor plan 500. Thus, dimensions may also be input or uploaded and associated with the floor plan 500 and the digital representation of the floor plan 500 which is provided on the device, e.g., laptop computer, etc. as noted above, which the owner or manager interacts with may be scaled to the dimensions of the facility.

In embodiments where the dimensions of the laundromat are also uploaded, the floor plan 500 may be scaled correspondingly to the uploaded dimensions, e.g., the floor plan 500 may be scaled to fit a display of the user interface device and may be scaled proportionally to the uploaded dimensions. The uploaded dimensions may include or correspond to a length and a width of the laundromat, e.g., where the laundromat is rectangular. For example, the floor plan 500 may be scaled according to the uploaded dimensions such that the size of icons representing laundry appliances in the laundromat is proportional to the size of the floor plan 500, such as to ensure accurate locations of the laundry appliances within the facility, e.g., laundromat, and accurate distances between the laundry appliances within the facility. For example, the ratio or relative size of the floor plan 500 as displayed on a screen may be proportional to the actual dimensions (e.g., as uploaded) of the laundromat and laundry appliances which are also displayed on the screen may share the same ratio of actual dimensions to on-screen dimensions as the one or more rooms, e.g., walls 502 thereof, in the floor plan 500.

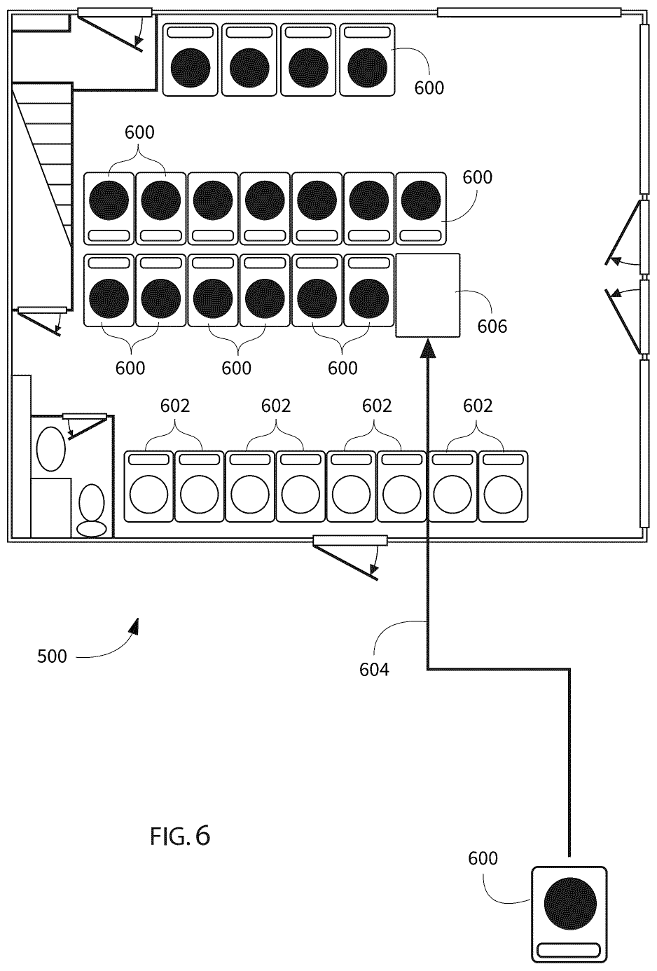

After the floor plan 500 is uploaded, the floor plan 500 may be accessed and displayed on a user interface device, such as in an application, e.g., “app,” running on a smartphone device, tablet computer, and/or other similar user interface device. As will be discussed further in regard to FIG. 6, commissioned laundry appliances may be displayed on or in the floor plan 500, e.g., in the app.

Turning now to FIG. 6, in some embodiments, a plurality of laundry appliances, e.g., a plurality of washing machine appliances 10 and a plurality of dryer appliances 11, may be identified on the floor plan 500. The laundry appliances may be represented by icons, such as washing machine icons 600, each of which represents one washing machine appliance 10 and dryer icons 602, each of which represents one dryer appliance 11. For example, the plurality of laundry appliances may be manually entered or selected by the owner on the floor plan 500. In some embodiments, for example as illustrated in FIG. 6, each appliance may be added to the floor plan 500 by a drag-and-drop interface, e.g., as illustrated in FIG. 6, a washing machine appliance 10 may be added to the plurality of laundry appliances on the floor plan 500 by dragging a representative washing machine icon 600 onto the floor plan 500, e.g., as represented by arrow 604, and dropping the representative icon into place at the location 606 in the floor plan 500, while the floor plan 500 is displayed on the screen of the user interface device, and where location 606 on the floor plan 500 corresponds to the actual location of the washing machine appliance 10 in the room, e.g., laundromat, represented by the floor plan 500. Thus, the floor plan 500 may be used in various methods which include setting up and managing the group of appliances which are present in the facility, e.g., the floor plan 500 and location information therein may be presented on a user interface in an interactive form to provide improved management, e.g., monitoring, maintenance, and/or operation, of one or more laundry appliances from the group of laundry appliances. For example, the owner or manager may be permitted to identify and/or define one or more laundry appliances or groups of laundry appliances via such interactive display derived from or based on the uploaded floor plan 500, e.g., images and dimension data.

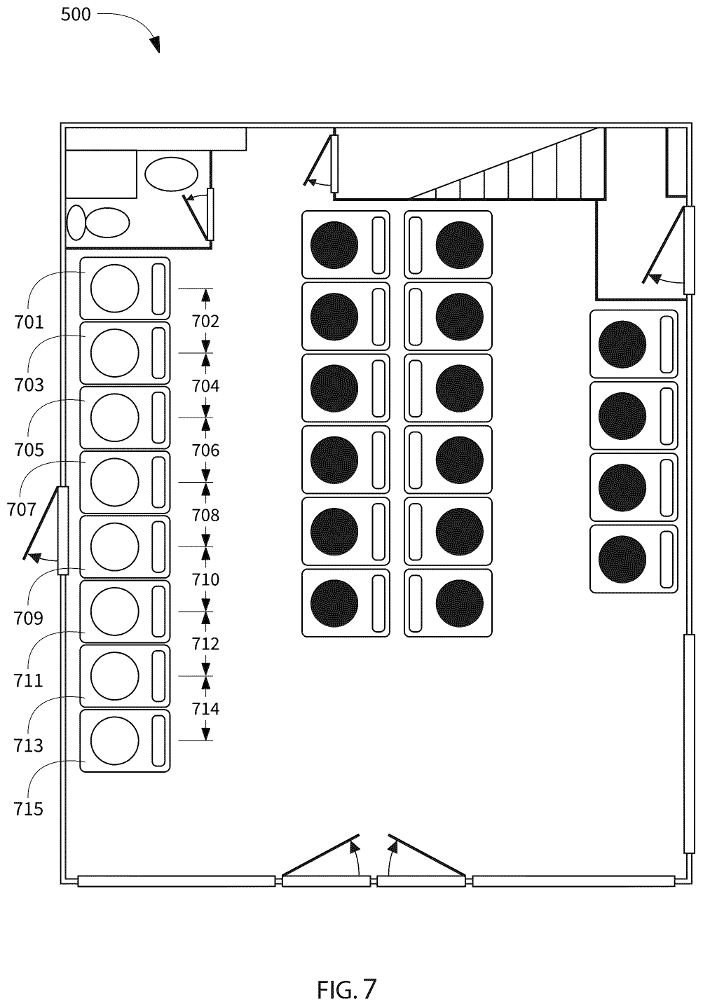

In some embodiments, e.g., as illustrated in FIG. 7, the floor plan 500 and the location information of the laundry appliances therein may be used to determine or calculate distances between various laundry appliances, such as each group of laundry appliances, where the groups of laundry appliances may be defined as described herein, e.g., in a laundromat management application software by the owner or manager, and may further be classified by type of laundry appliance, e.g., a group of washing machine appliances and a group of dryer appliances. For example, a group of dryer appliances is illustrated in FIG. 7. The floor plan 500 and the location information of the laundry appliances therein may be used to determine or calculate distances between each dryer appliance 11 represented by a dryer appliance icon 602 (FIG. 6) and between each washing machine appliance 10 represented by a washing machine icon 600 (FIG. 6). The group of dryer appliances illustrated in FIG. 7 is provided as one example, and methods disclosed herein may also be used with a group of laundry appliances which consists of washing machine appliances.

As may be seen in FIG. 7, the group of laundry appliances may consist of dryer appliances, each of which is represented by a dryer icon in FIG. 7. Thus, the group of dryer appliances may include, e.g., a first dryer appliance represented by dryer icon 701, a second dryer appliance represented by dryer icon 703, a third dryer appliance represented by dryer icon 705, a fourth dryer appliance represented by dryer icon 707, a fifth dryer appliance represented by dryer icon 709, a sixth dryer appliance represented by dryer icon 711, a seventh dryer appliance represented by dryer icon 713, and an eighth dryer appliance represented by dryer icon 715.

Each laundry appliance in the group of laundry appliances, e.g., each of the dryer appliances, may be a distance from one or more adjacent appliances of the group of laundry appliances. For example, the second dryer appliance may be a first distance 702 from the first dryer appliance and a second distance 704 from the third dryer appliance, and such distances may be scaled from the floor plan 500 and may be displayed on a digital representation of the facility, e.g., a digital representation of the floor plan of the facility. The distances between each set of neighboring appliances may be the same or may vary. A distance between non-neighboring appliances may be determined by summing the distances between the two appliances and all intervening appliances. Thus, turning again to the example illustrated in FIG. 7, a third distance 706 may be determined or calculated between the third dryer appliance and the fourth dryer appliance, a fourth distance 708 may be determined or calculated between the fourth dryer appliance and the fifth dryer appliance, a fifth distance 710 may be determined or calculated between the fifth dryer appliance and the sixth dryer appliance, a sixth distance 712 may be determined or calculated between the sixth dryer appliance and the seventh dryer appliance, and a seventh distance 714 may be determined or calculated between the seventh dryer appliance and the eighth dryer appliance. As noted above, each of the foregoing distances may be the same or may vary. Thus, for example, the distance between the first dryer appliance (represented by dryer icon 701) and the eighth dryer appliance (represented by dryer icon 715) may be determined by adding all of the distances 702, 704, 706, 708, 710, 712, and 714; or, when the distances between neighboring appliances are all the same (or within a margin, such as are approximately equal), e.g., when each distance is “X,” by multiplying the distance (e.g., X). For example, the eighth dryer appliance is seven appliances away from the first dryer appliance, so the distance between the first dryer appliance and the eighth dryer appliance may be determined by multiplying the number of appliances by the uniform distance between neighboring appliances, e.g., 7× in this example. Similarly, the distance between the third dryer appliance and the fifth dryer appliance may be determined by summing distances 706 and 708, or by multiplying the common distance (when all the distances are equal or approximately equal, as discussed) by two.

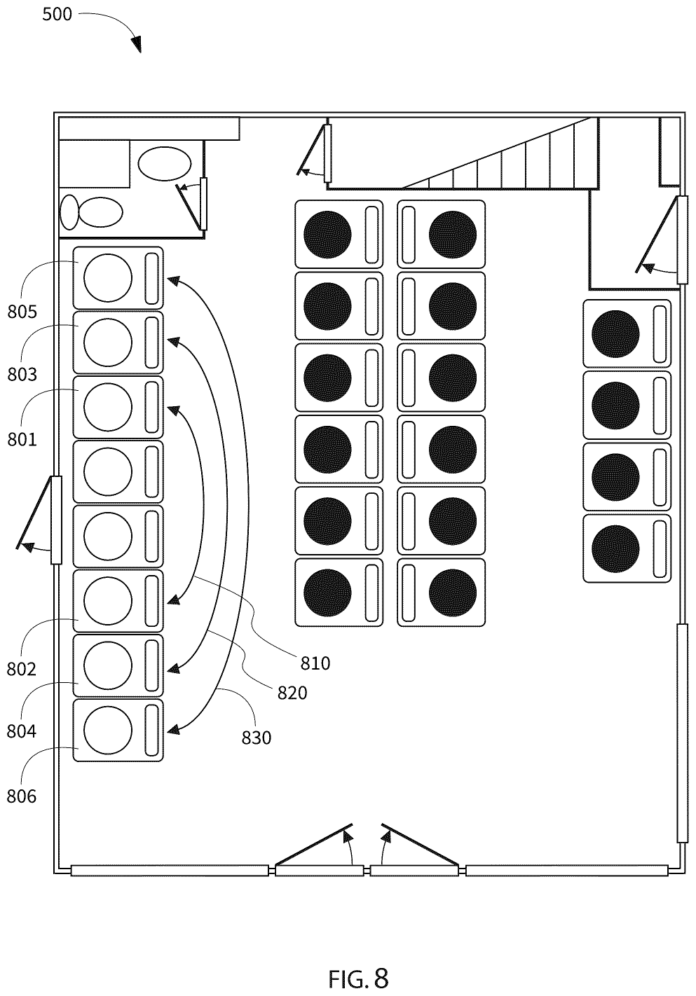

Referring now to FIG. 8, some embodiments of the present disclosure may also include identifying a first set of laundry appliances from the group of laundry appliances and a second set of laundry appliances from the group of laundry appliances. The sets may be identified by the volume of traffic each laundry appliance receives, e.g., by how heavily used each laundry appliance is. For example, as noted in FIG. 8, the first set of laundry appliances, which may be a high volume usage set, may include a first high-volume laundry appliance 801 which is (in this example) the most heavily used laundry appliance of the group of laundry appliances, a second high-volume laundry appliance 803 which is, e.g., the second-most heavily used, and a third high-volume laundry appliance 805 which is, e.g., the third-most heavily used out of the entire group of laundry appliances (e.g., all of the dryer appliances in the laundromat in this example). Continuing the example, the second set of laundry appliance may be a low volume usage set, and may include a third low-volume laundry appliance 806 which is (in this example) the least used laundry appliance of the group of laundry appliances, a second low-volume laundry appliance 804 which is, e.g., the second-least used laundry appliance, and a first low-volume laundry appliance 802 which is, e.g., the third-least used laundry appliance.

As may be seen from FIG. 8, the facility, e.g., laundromat, may include high traffic zones or areas and low traffic zones or areas. For example, laundry appliances in an area or zone closer to the front doors of the laundromat may receive less traffic whereas other laundry appliances in another area or zone closer to the rear of the laundromat may receive more traffic, e.g., a larger portion of the total number of cycles performed by all of the laundry appliances, e.g., dryers, in the laundromat may be performed by the laundry appliances in high-traffic zones than by the laundry appliances in low-traffic zones.

Also as may be seen from FIG. 8, the first set of laundry appliances and the second set of laundry appliances may collectively include less than all of the laundry appliances in the group of laundry appliances. For example, as may be seen in FIG. 8, two middle laundry appliances are not included in either the first set or the second set. The middle laundry appliances may be used about the average amount, or may otherwise receive more than a minimal amount of usage (such that they are not included in the second set) and less than a maximum amount of usage (such that they are also not included in the first set). In additional embodiments, only one laundry appliance from the group of laundry appliances may be omitted from the first and second sets, or more than two laundry appliances from the group of laundry appliances may be omitted from the first and second sets, or all of the laundry appliances from the group of laundry appliances may be included in one or the other of the first set and the second set.

Embodiments of the present disclosure may further include providing a recommendation to relocate at least one laundry appliance from the first set of laundry appliances or the second set of laundry appliances, such as recommending to move a low-volume laundry appliance to a high-traffic zone and/or to move a high-volume laundry appliance to a low-traffic zone, such that the total usage of each laundry appliance in the group of laundry appliances may be more equalized over time (e.g., after relocation). For example, the laundry appliances may be swapped between the zones. In embodiments where the recommended relocation is or includes swapping laundry appliances, the order of swapping may be determined starting with either set, such as starting with the most used laundry appliance and recommending to swap it with the closest low-volume laundry appliance, then recommending to swap the second-most used laundry appliance with the closest remaining low-volume laundry appliance to the second-most used laundry appliance, and so on. Alternatively, the order of recommended swapping may begin with the second set, such as starting with the least used laundry appliance and recommending to swap it with the closest high-volume laundry appliance to the least used laundry appliance, then recommending to swap the second-least used laundry appliance with the closest remaining high-volume laundry appliance to the second-least used laundry appliance, and so on. As illustrated in the example of FIG. 8, the recommendation to relocate at least one laundry appliance from the first set of laundry appliances or the second set of laundry appliances may be or may include recommendation to swap three high-volume laundry appliances with three low-volume laundry appliances. For example, as indicated by arrow 810 (which may be provided as a graphical element on a computer display overlaid on the floor plan 500) the recommendation may include recommending to swap the most heavily used laundry appliance, e.g., the first high-volume laundry appliance 801, with the closest low-volume laundry appliance to the first high-volume laundry appliance 801, e.g., which is the first low-volume laundry appliance 802 in this example. The recommendation may further include recommending to swap the second-most heavily used laundry appliance, e.g., the second high-volume laundry appliance 803, with the closest low-volume laundry appliance to the second high-volume laundry appliance 803, e.g., which is the second low-volume laundry appliance 804 in this example, as indicated by arrow 820 in FIG. 8. Additionally, the third-most heavily used laundry appliance may be recommended to be swapped with the closest remaining low-volume laundry appliance to the third-most heavily used laundry appliance, e.g., third high-volume laundry appliance 805 may be recommended to be swapped with the third low-volume laundry appliance 806, as indicated by arrow 830 in FIG. 8.

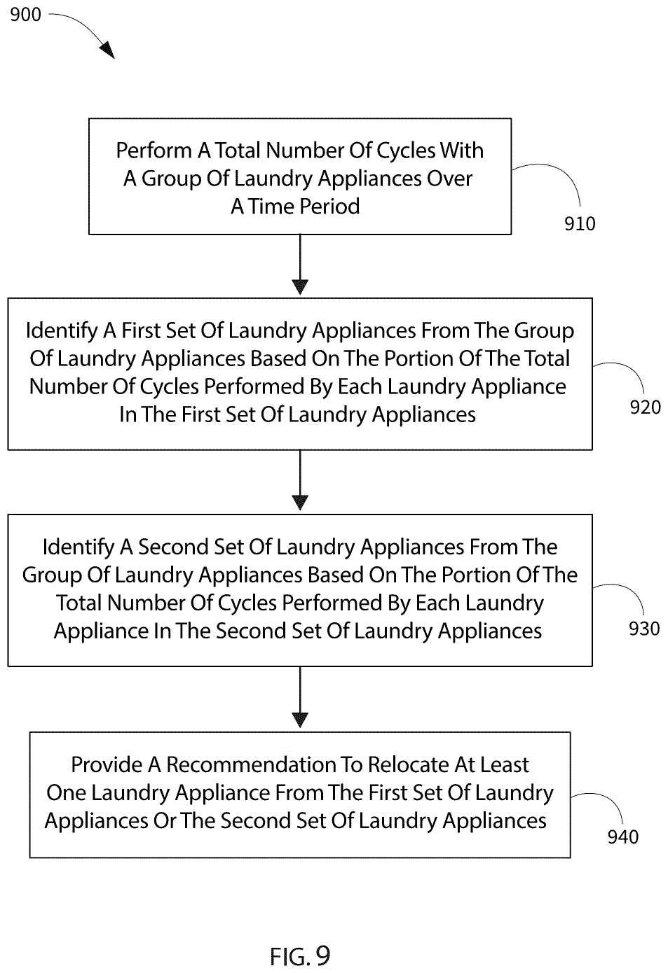

As illustrated in FIG. 9, embodiments of the present disclosure also include methods of operating a group of laundry appliances, e.g., a group of laundry appliances such as a group of washing machine appliances 10 described above, or a group of dryer appliances 11 described above, among other possible exemplary laundry appliances. Exemplary methods according to the present subject matter include the method 900 illustrated in FIG. 9. Such methods may be wholly or partially computer-implemented, such as implemented by a controller, e.g., controller 210, of one or more laundry appliances and/or implemented by one or more remote computing devices, e.g., in the cloud, fog, and/or edge.

As illustrated in FIG. 9, the method 900 may include (910) performing a total number of cycles with the group of laundry appliances over a time period. Each laundry appliance of the group of laundry appliances performs a portion of the total number of cycles, although the portion may be as low as zero for some laundry appliances. The time period may be, for example, a month, a quarter of a year (e.g., three months), a year, or any other suitable time period, such as eighteen months or two years, etc. Thus, in most cases, every laundry appliance in the group of laundry appliances will be used at least occasionally over the course of the period of time. Additionally, the period of time may be long enough that clear trends in the usage patterns of the laundry appliance in the group of laundry appliances may be discerned.

It should also be understood that each cycle of the total number of cycles includes causing at least one mechanical component of the respective laundry appliance to be operated. For example, when the group of laundry appliances is a group of washing machine appliances, each cycle may include opening and closing one or more valves, activating one or more pumps or motors, flowing various fluids, and/or rotating a basket, or, when the group of laundry appliances is a group of dryer appliances, each cycle may include rotating the drum, activating the heating system, etc., as is understood by those of ordinary skill in the art. Also, operating the mechanical component during each cycle includes changing a physical status of the component, e.g., a speed, position, etc. of the component, such as accelerating the motor, fan, etc., e.g., from a zero starting speed, opening a valve, and/or other changes in the physical state of one or more mechanical components of the respective laundry appliance from the group of laundry appliances.

Referring still to FIG. 9, method 900 may further include (920) identifying a first set of laundry appliances from the group of laundry appliances based on the portion of the total number of cycles performed by each laundry appliance in the first set of laundry appliances. In such embodiments, the first set of laundry appliances may include high-volume or high-use laundry appliances, e.g., as described above. For example, the first set of laundry appliances may include those laundry appliances which performed more than a threshold amount or proportion of the total number of cycles, or may be identified by comparison of the number of cycles performed by each laundry appliance with an average number of cycles per appliance (e.g., the total number of cycles performed during the time period by all laundry appliances in the group of laundry appliances divided by the number of laundry appliances in the group of laundry appliances). Method 900 may also include (930) identifying a second set of laundry appliances from the group of laundry appliances based on the portion of the total number of cycles performed by each laundry appliance in the second set of laundry appliances. In such embodiments, the second set of laundry appliances be low-volume or low-use laundry appliances, and may be identified similarly as the first set, e.g., with reference to a threshold amount or proportion of cycles performed, an average number of cycles per laundry appliance, or other similar standard for identification of low-use laundry appliances.

In some embodiments, the first set of laundry appliances may be those laundry appliances from the group of laundry appliances that exceeded the average number of cycles per unit over the period of time by at least a first threshold amount, and the second set of laundry appliances may be those laundry appliances from the group of laundry appliances that performed less than the average number of cycles per unit over the period of time by at least a second threshold amount. For example, in some embodiments, method 900 may include determining an average of the total number of cycles per laundry appliance. In such embodiments, the first set of laundry appliances may be identified based on each of the high-use laundry appliances having performed more than the average number of cycles per laundry appliance, and the second set of laundry appliance may be identified based on each of the low-use laundry appliances having performed less than the average number of cycles per laundry appliance. For example, the first threshold amount may be twice the average and the second threshold amount may be half the average, such as each of the high-use laundry appliances performed more than twice the average number of cycles per laundry appliance and each of the low-use laundry appliances performed less than half the average number of cycles per laundry appliance.

Also as may be seen in FIG. 9, method 900 may further include (940) providing a recommendation to relocate at least one laundry appliance from the first set of laundry appliances or the second set of laundry appliances. The recommendation may be provided by comparison of the amount of usage of the various laundry appliances in each set, and may be designed to provide a more balanced and even distribution of usage among the laundry appliances of the group of laundry appliances, e.g., moving one or more low-use laundry appliances to a high-use zone and/or moving one or more high-use laundry appliances to a low-use zone, such as swapping the locations of a low-use laundry appliance and a high-use laundry appliance. After the one or more laundry appliances are relocated, the group of laundry appliances may perform an additional number of cycles over a subsequent period of time and, after the subsequent period of time, the total usage (e.g., total number of cycles performed) by each laundry appliance in the group of laundry appliances across both periods of time may advantageously be more evenly distributed as a result of such location.

For example, in some embodiments, the recommendation to relocate at least one laundry appliance from the first set of laundry appliances or the second set of laundry appliances may include a recommendation to swap locations of at least one laundry appliance from the first set of laundry appliances with at least one laundry appliance from the second set of laundry appliances, e.g., in such embodiments an equal number of laundry appliances from each set may be relocated, such as the first set of laundry appliances and the second set of laundry appliances may each include the same number of laundry appliances. For example, one laundry appliance from the first set of laundry appliances may be recommended to swap locations with one corresponding laundry appliance from the second set of laundry appliances. As another example, two laundry appliance from the first set of laundry appliances may be recommended to swap locations, each with one corresponding laundry appliance from the second set of laundry appliances for a total of two laundry appliances from the second set of laundry appliances being recommended to relocate, e.g., swap locations, or, in additional examples, three or more laundry appliances from each set of laundry appliances may be recommended to swap locations. In such embodiments, if one of the sets of laundry appliances is initially smaller than the other set of laundry appliances, the next laundry appliance may be added to the smaller set in order to equalize the sets so that each laundry appliance has a corresponding partner to swap with. For example, when the first set of laundry appliances is defined based on performing at least twice the average numbers of cycles during the time period and the second set of laundry appliances is defined based on performing less than half the average numbers of cycles during the time period, and the first set is smaller than the second set, the laundry appliance from the group of laundry appliances that performed the next-highest amount of cycles during the time period (e.g., while still less than twice the average) may be added to the first set in order to equalize the sets. Similarly, when the second set is initially smaller, one or more additional laundry appliances may be added (e.g., which performed the next fewest cycles during the time period but above the threshold for inclusion in the second set) to the second set in order to provide a swapping partner for every appliance in the first set of laundry appliances.

In some embodiments, method 900 may further include determining which laundry appliance from the second set of laundry appliances is closest to each laundry appliance from the first set of laundry appliances, such that the recommendation to swap locations includes a recommendation to swap locations with the closest laundry appliance from the second set of laundry appliances. For example, the recommendation to relocate may be or may include a recommendation to swap the location of a laundry appliance from one set of laundry appliances with one corresponding laundry appliance from the other set of laundry appliances, and the one corresponding laundry appliance from the other set of laundry appliances may be the closest laundry appliance in the other set of laundry appliances to the laundry appliance from the one set of laundry appliances.

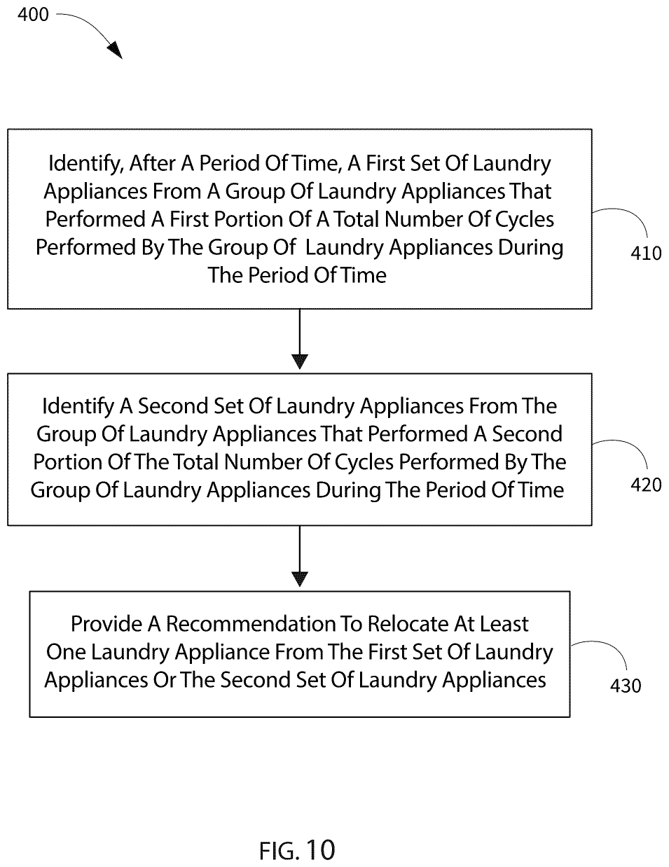

Turning now to FIG. 10, another exemplary method 400 of operating a group of laundry appliances is illustrated therein. The group of laundry appliances may include two or more washing machine appliances or two or more dryer appliances. The method 400 may include (410) identifying, after a period of time, a first set of laundry appliances from the group of laundry appliances. The first set of laundry appliances may include all laundry appliances from the group of laundry appliances that each performed a first portion of a total number of cycles performed by the group of laundry appliances during the period of time. Method 400 may further include (420) identifying a second set of laundry appliances from the group of laundry appliances. The second set of laundry appliances may include all laundry appliances from the group of laundry appliances that each performed a second portion of the total number of cycles performed by the group of laundry appliances during the period of time. The second portion may be less than the first portion.

Method 400 may also include (430) providing a recommendation to relocate at least one laundry appliance from the first set of laundry appliances or the second set of laundry appliances. As noted above with respect to method 900, such relocation may provide or result in more evenly distributed usage of the laundry appliances in the group of laundry appliances, e.g., relocating a high-volume laundry appliance to a low-traffic zone may result in reduced load on that appliance and/or relocating a low-volume laundry appliance to a high-traffic zone may result in increased usage of that appliance, such that the total usage of each appliance evens out over time.

For example, the recommendation to relocate at least one laundry appliance from the first set of laundry appliances or the second set of laundry appliances may include a recommendation to swap locations of at least one laundry appliance from the first set of laundry appliances with at least one laundry appliance from the second set of laundry appliances. In such embodiments, method 400 may further include determining which laundry appliance from the second set of laundry appliances is closest to each laundry appliance from the first set of laundry appliances, such that the recommendation to swap locations comprises a recommendation to swap locations with the closest laundry appliance from the second set of laundry appliances. For example, determining which laundry appliance from the second set of laundry appliances is closest to each laundry appliance from the first set of laundry appliances may be based on a floor plan, e.g., the floor plan may include location information of each laundry appliance from the group of laundry appliances.

Method 400 may further include determining an average of the total number of cycles per laundry appliance. In such embodiments, the first portion of the total number of cycles may be more than the average number of cycles per laundry appliance, and the second portion of the total number of cycles may be less than the average number of cycles per laundry appliance. For example, the first portion of the total number of cycles may be more than twice the average number of cycles per laundry appliance and/or the second portion of the total number of cycles may be less than half the average number of cycles per laundry appliance.

Referring now generally to FIGS. 9 and 10, the methods 400 and/or 900 may be interrelated and/or may have one or more steps from one of the methods 400 and 900 combined with the other method 400 or 900. Thus, those of ordinary skill in the art will recognize that the various steps of the exemplary methods described herein may be combined in various ways to arrive at additional embodiments within the scope of the present disclosure.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

In some embodiments, the laundry appliances that are recommended to swap locations, e.g., which are closest to each other and are members of opposite sets of laundry appliances, may be determined based on a floor plan. In such embodiments, the floor plan may include location information of each laundry appliance from the group of laundry appliances. For example, the floor plan may be uploaded to a remote computing device, and the location information of each laundry appliance may be added to the floor plan, either before or after the upload, such as via a user interface including icons which represent locations of washing machine appliances and dryer appliances of the group of laundry appliances within the room represented by the floor plan. For example, the location information may be added to the floor plan after the floor plan is scaled based on the actual dimensions of the room, e.g., whereby the icons representing each laundry appliance may be appropriately proportioned relative to the overall floor plan and to each other, such as with respect to distances between each laundry appliance. The floor plan may be uploaded after the dimensions are entered and the appliance location information is received, or the scaling and locating may be performed, in whole or in part, using the remote computing device after uploading the basic floor plan to the remote computing device.

In some embodiments, methods according to the present disclosure may include receiving, by a remote computing device, an upload comprising a floor plan of a facility, e.g., the group of laundry appliances may be located in the facility, such as in one or more rooms thereof. In such embodiments, the method may include receiving, by the remote computing device, location information for each laundry appliance of the group of laundry appliances, such as from a remote user interface device such as a computer, e.g., tablet computer or desktop computer, etc., or smartphone. Such embodiments may further include receiving, by the remote computing device, dimensions of the facility, and scaling the floor plan and the location information for each laundry appliance based on the dimensions, e.g., in such embodiments, the scaling of the floor plan may be performed in the remote computing device, whereas in additional embodiments, the scaling of the floor plan may also or instead be performed by the remote user interface device, such as prior to the upload and/or as a check on the accuracy of the scaling. Also in such embodiments, a second laundry appliance that is recommended to be swapped with a first laundry appliance, e.g., the second laundry appliance which is closest to the first laundry appliance may be determined, e.g., by the remote computing device, based on the floor plan.

In some exemplary embodiments, the present disclosure may include a visual representation of the group of laundry appliances and the relative positions/distances between each laundry appliance in the group of laundry appliances, e.g., on the floor plan 500. The visual representation may be presented, e.g., on a display of a remote user interface device, such as a touchscreen display, computer monitor, etc. For example, laundry appliances which are recommended for relocation may be highlighted or circled on the floor plan on a display of the remote user interface device.

It should be understood that the foregoing method steps, e.g., of method 400 and/or method 900, may be performed by the remote user interface device, such as in an app running on, e.g., a smartphone or tablet. In some embodiments, one or more methods according to the present disclosure may be computer-implemented, such as implemented at least in part by a remote computing device, e.g., in a distributed computing environment such as the cloud, fog, and/or edge, as mentioned above. Such embodiments may also include one or more steps performed by a remote user interface device which is in communication with the remote computing device, where the remote user interface device and the remote computing device are both remote from the laundry appliances, e.g., as described above with respect to FIG. 4, and are remote from each other.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a group of laundry appliances, the method comprising:
performing a total number of cycles with the group of laundry appliances over a time period, wherein each laundry appliance of the group of laundry appliances performs a portion of the total number of cycles;
identifying a first set of laundry appliances from the group of laundry appliances based on the portion of the total number of cycles performed by each laundry appliance in the first set of laundry appliances, wherein the first set of laundry appliances comprises high-use laundry appliances;
identifying a second set of laundry appliances from the group of laundry appliances based on the portion of the total number of cycles performed by each laundry appliance in the second set of laundry appliances, wherein the second set of laundry appliances comprises low-use laundry appliances; and
providing a recommendation to relocate at least one laundry appliance from the first set of laundry appliances or the second set of laundry appliances.

2. The method of claim 1, wherein the recommendation to relocate at least one laundry appliance from the first set of laundry appliances or the second set of laundry appliances comprises a recommendation to swap locations of at least one laundry appliance from the first set of laundry appliances with at least one laundry appliance from the second set of laundry appliances.

3. The method of claim 2, further comprising determining which laundry appliance from the second set of laundry appliances is closest to each laundry appliance from the first set of laundry appliances, wherein the recommendation to swap locations comprises a recommendation to swap locations with the closest laundry appliance from the second set of laundry appliances.

4. The method of claim 3, wherein determining which laundry appliance from the second set of laundry appliances is closest to each laundry appliance from the first set of laundry appliances is based on a floor plan, the floor plan comprising location information of each laundry appliance from the group of laundry appliances.

5. The method of claim 1, further comprising determining an average of the total number of cycles per laundry appliance, wherein the first set of laundry appliance is identified based on each of the high-use laundry appliances having performed more than the average number of cycles per laundry appliance, and wherein the second set of laundry appliance is identified based on each of the low-use laundry appliances having performed less than the average number of cycles per laundry appliance.

6. The method of claim 5, wherein each of the high-use laundry appliances performed more than twice the average number of cycles per laundry appliance.

7. The method of claim 5, wherein each of the low-use laundry appliances performed less than half the average number of cycles per laundry appliance.

8. The method of claim 1, wherein the period of time is three months.

9. The method of claim 1, wherein the first set of laundry appliances and the second set of laundry appliances each comprise the same number of laundry appliances, wherein the recommendation to relocate at least one laundry appliance from the first set of laundry appliances or the second set of laundry appliances comprises a recommendation to swap locations of each laundry appliance from the first set of laundry appliances with one corresponding laundry appliance from the second set of laundry appliances.

10. A method of operating a group of laundry appliances, the method comprising:
identifying, after a period of time, a first set of laundry appliances from the group of laundry appliances, wherein the first set of laundry appliances performed a first portion of a total number of cycles performed by the group of laundry appliances during the period of time;
identifying a second set of laundry appliances from the group of laundry appliances, wherein the second set of laundry appliances performed a second portion of the total number of cycles performed by the group of laundry appliances during the period of time, the second portion less than the first portion; and
providing a recommendation to relocate at least one laundry appliance from the first set of laundry appliances or the second set of laundry appliances.

11. The method of claim 10, wherein the recommendation to relocate at least one laundry appliance from the first set of laundry appliances or the second set of laundry appliances comprises a recommendation to swap locations of at least one laundry appliance from the first set of laundry appliances with at least one laundry appliance from the second set of laundry appliances.

12. The method of claim 11, further comprising determining which laundry appliance from the second set of laundry appliances is closest to each laundry appliance from the first set of laundry appliances, wherein the recommendation to swap locations comprises a recommendation to swap locations with the closest laundry appliance from the second set of laundry appliances.

13. The method of claim 12, wherein determining which laundry appliance from the second set of laundry appliances is closest to each laundry appliance from the first set of laundry appliances is based on a floor plan, the floor plan comprising location information of each laundry appliance from the group of laundry appliances.

14. The method of claim 10, further comprising determining an average of the total number of cycles per laundry appliance, wherein the first portion of the total number of cycles is more than the average number of cycles per laundry appliance, and wherein the second portion of the total number of cycles is less than the average number of cycles per laundry appliance.

15. The method of claim 14, wherein the first portion of the total number of cycles is more than twice the average number of cycles per laundry appliance.

16. The method of claim 14, wherein the second portion of the total number of cycles is less than half the average number of cycles per laundry appliance.

17. The method of claim 10, wherein the period of time is three months.

18. The method of claim 10, wherein the first set of laundry appliances and the second set of laundry appliances each comprise the same number of laundry appliances, wherein the recommendation to relocate at least one laundry appliance from the first set of laundry appliances or the second set of laundry appliances comprises a recommendation to swap locations of each laundry appliance from the first set of laundry appliances with one corresponding laundry appliance from the second set of laundry appliances.
